(19) United States
(12) Patent Application Publication
(10) Pub. No.: US 2002/0006810 A1
(43) Pub. Date: Jan. 17, 2002

(54) Antenna changeover switch for transmit-receive units in a mobile station

(76) Inventor: Heiko Schiller, Ulm (DE)

Correspondence Address: PERMAN & GREEN, 425 POST ROAD, FAIRFIELD, CT, 06430, US

(21) Appl. No.: 09/896,606

(22) Filed: Jun. 29, 2001

(30) Foreign Application Priority Data
Jun. 30, 2000 (DE) DE 10030982.8

(51) Int. Cl. H04M 1/00

(52) U.S. Cl. 455/552; 455/82

(57) ABSTRACT

The invention relates to an antenna changeover switch for transceivers in a mobile station, designed for operation in at least two discrete HF transmission bands. For this purpose diode switches (D1 to D4) with HF impedance transformers are often used, which switch between channels of the GSM 900 network and channels of the DCS 1800 network. Owing to inadequate decoupling between the transceivers an appreciable portion of the transmitting signal from the active transceiver (TX1 or TX2) will arrive at the antenna terminal of the inactive transceiver. Therein in particular a portion coupled into the antenna terminal (A2) of the DCS 1800 transceiver by the GSM 900 transceiver can be so large that the currentless semiconductor components connected there generate harmonic waves. The problem is solved according to the invention in that controls (S1, S2) simultaneously conductively control the switch diodes (D1 and D2) in the GSM 900 transceiver and a switch diode (D4) located parallel to the signal input of the receiving unit (RX2) in the other transceiver with a bias current.

### DESCRIPTION

The invention relates to an antenna changeover switch for transmit-receive units in a mobile station, designed for operation in at least two discrete HF transmission bands. The antenna changeover switch is used in particular in mobile stations which use, for example, both channels of the GSM 900 network with carrier frequencies of around 900 MHz and channels of the DCS 1800 network, the carrier frequencies of which are around 1800 MHz. A mobile station in the sense of this document may be a mobile telephone, a telematics unit in a vehicle or some other mobile device with a radio network connection. Corresponding stations are also designated as dual-band or multi-band devices. The transmit-receive unit is designated below as a receiver. The invention can, however, also be applied to multi-band devices with different transmission bands.

Conventional mobile telephones for digital radio networks often use the same antenna for both transmitting and receiving in all HF transmission bands if the transmission is taking place in time-multiplex operation and the two transmission devices use different time slots. An antenna changeover switch enables alternative operation of the antenna for transmitting and receiving.

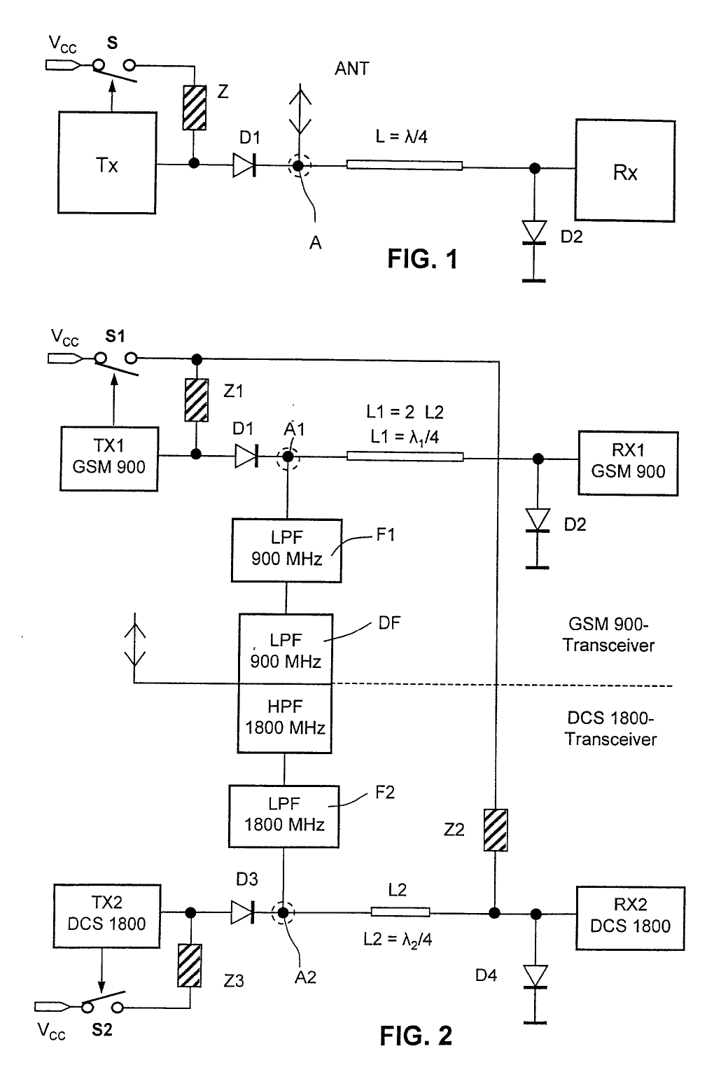

If the mobile telephone is designed only for an HF transmission band the antenna changeover switch contains simple, known diode switches. A known solution of this kind is shown in FIG. 1. A transmitting unit TX provides a transmitting signal modulated on a carrier for the connection direction to the radio network, in other words during transmitting. Connected to an antenna terminal A is a transmit-receive antenna ANT which sends the modulated transmitting signal to the radio network. The same antenna ANT also receives a modulated receiving signal on a different carrier for the opposite direction of the connection from the radio network. The transmitting unit TX is connected to the antenna terminal A via a serially placed diode D1, in order to avoid affecting the receiving signal with its output. In series to the input of the receiving unit RX is a transformer L and parallel to the input a second diode D2 which prevents the transmitting signal from being affected. In the conducting state, in other words during transmitting, the diodes D1, D2 have a particularly low dynamic inherent resistance to keep power loss of the transmitting signal low. For example, PIN diodes are used. The transformer L is a two or four terminal network tuned to the HF transmission band, which transforms an HF impedance located at one end to the other end in such a way that if there is a short circuit at the other end an open circuit acts and the other way round. This can be achieved, for example, with L/C four terminal networks. Advantageously, however, an HF line with a length L=λ/4 is used, which produces a signal reflex with a phase displacement of 180° for signals located in the transmission band. The wavelength λ is the average wavelength of the HF transmission band. If there is a terminating resistance at one end, HF energy can be transmitted to there from the other end without reflex.

An impedance Z leads a switching signal to connection between the output of the receiving unit RX and the connection of the diode D1 which is serial to the output. The switching signal is, for example, controlled by a switch S which in transmitting mode sends a bias current through the diodes.

Both diodes D1 and D2 are thereby conductive. Owing to the conductive diode D1 the HF output power of the transmitting unit TX arrives at the antenna terminal A with low attenuation, while the equally conductive diode D2 short circuits the input of the receiving unit RX. The λ/4 line L transforms the short circuit of the input of the receiving unit RX into an open circuit impedance, so the connection of the antenna terminal A to the receiving unit RX is practically cut and does not affect the transmitting signal.

In receiving mode there is no bias current, the diode D1 interrupts the signal supply to the transmit-receive antenna ANT and the diode 2 removes the short circuit at the input of the receiving unit RX. The receiving signal of the antenna ANT arrives via the λ/4 line terminated by the input resistance of the receiving unit RX at the receiver RX. The solution described is known from, among others, DE 199 08 594 and functions in practically any HF transmission band.

The serial connection of the diodes in the antenna changeover switch has a decisive advantage for a mobile station supplied by a battery in respect of the requirement of operational energy. A bias current flows through the diodes only in a relatively short transmitting mode. Usually, however, a mobile station is predominantly in standby operation and is waiting for the reception of a correspondingly addressed receiving signal. This arrives at the receiver RX without a bias current flowing through the diodes and thus lowers the current consumption of the batteries of the device in the receiving mode.

A dual-band device, for example for the channels of the GSM 900 and the DCS 1800 band, often has a separate transceiver for each transmission band with its own receiving unit RX1 or RX2 and a separate transmitting unit TX1 and TX2, which use a transmit-receive antenna in common. Each of the receiving units is connected to the corresponding transmitting unit TX1 or TX2 via a diode switch D1, D2, L1 or D3, D4, L2. The lengths of the λ/4 lines L1 or L2 in the diode switches correspond to the average wavelengths of the receiving channels of the corresponding HF transmission band. I.e. line L1 is approximately twice as long as line L2. The antenna outputs A1 and A2 of the transceivers are guided via a so-called diplex filter DF to the common antenna ANT. The diplex filter DF forms a low-pass filter between antenna ANT and the GSM 900 transceiver and a high-pass filter to the DCS 1800 transceiver, decouples the two transceivers from one another and conditionally prevents any effect of the inactive transceiver on the transmitting receiver. Owing to the selectivity of the diplex filter DF a signal received in the receiving mode arrives at the corresponding receiving unit without a bias current activating a changeover switch. In each transceiver is a switch S1, S2 which actuates the diode switches D1, D2 or D3, D4 in the transmission branches with a bias current. As long as the mobile station is transmitting a control device in the transceiver of the active HF transmission band closes the corresponding switch S1 or S2 in order to guide the HF transmitting power from the corresponding transmitting unit TX1 or TX 2 to the antenna ANT.

The diplex filter DF can be replaced by further diode switches. These would, however, cause an additional internal loss of HF transmitting power in the respectively active transmitting branch. Further, the corresponding diode switch from the antenna ANT to the corresponding receiving unit would also have to be closed by a bias current during reception. Both reduce the operational time of a mobile station with accumulator charge, in particular during standby operation.

The switch diodes in the antenna changeover switch described cause a basic problem, however. If the signal amplitude of the transmitting signal exceeds a certain level, harmonic waves arise as a result of the non-linear transmission characteristics of the diodes in the transmitting signal. If the antenna ANT radiates these harmonic waves in addition to the transmitting signal, other radio services can be affected by this. This problem exists because of the ratio of the channel carrier frequencies of the two HF transmission bands to one another, particularly during transmission in the GSM 900 band. Then the first harmonic wave of the transmitting frequency is located partially directly on a fundamental wave of the DCS 1800 channel.

The GSM 900 transmitting frequencies of mobile stations are, for example, between 890 MHz and 915 MHz, while the DCS 1800 receiving frequencies are between 1805 MHz and 1880 MHz. Therefore the first harmonic waves from a part of the GSM 900 transmitting frequencies fall exactly in the range of DCS 1800 receiving frequencies. The problem intensifies with increasing receiver power, which may be two Watts with a GSM 900 mobile telephone and as much as eight Watts with a car telephone.

Practice has proved that owing to inadequate decoupling between the transceivers conditional upon the structure and properties of the printed circuit board and the diplex filter, an appreciable portion of the transmitting signal from the active transceiver arrives at the antenna terminal of the inactive transceiver. Thereby in particular a portion coupled in from the GSM 900 transceiver into the antenna terminal A2 of the DSC 1800 transceiver can be so large that the currentless semiconductor components connected there, such as the diodes D3, D4, and the internal cicuits of the receiving unit RX2 or the transmitting unit TX2 generate harmonic waves. As the frequency range of the first harmonic waves and the DCS 1800 transmission band are partially equal no filter can further prevent the first harmonic wave from the antenna terminal A2 arriving at the antenna ANT. In the reverse case this problem is easily solved, for example by an additional low-pass filter tuned to maximum transmitting frequency of the GSM 900 band between the diplex filter DF and the antenna terminal A1. Though an expensive band filter between the antenna terminal A2 and the antenna ANT or a notch filter at the antenna terminal A2 can reduce the portion of the coupled in GSM 900 signal, it increases both expenditure on circuits and loss of transmitting power in the DCS 1800 band.

Based on the problem described, the object of the invention is to create a solution which suppresses the formation of harmonic waves with the simplest possible means and low expenditure.

To achieve the object the present invention starts from an antenna changeover switch for transmit-receive units in a mobile station of the kind initially described. The changeover switch has a transceiver for an upper transmission band and at least one second transceiver for a lower transmission band.

Each transceiver has both a separate transmitting unit and a separate receiving unit, as well as an antenna terminal. In addition each transceiver contains a first switch diode, located from the antenna terminal serially to the transmitting output of the transmitting unit, and a second switch diode located parallel to the signal input of the receiving unit. An HF impedance transformer, located from the antenna terminal serially to the input of the receiving unit, transforms a short circuit of the signal input into an open circuit at the antenna terminal for signal frequencies in the corresponding transmission band. Each transceiver contains controls which put the first and second switch diodes into a conducting state by means of a bias current when the transceiver is actively transmitting, so the signal output of the active transmitting unit is connected to a common transmit-receive antenna via the antenna terminal and the signal input of the receiving unit is short circuited.

To suppress a portion of a signal which the transceiver of the lower transmission band is coupling into the antenna terminal of the transceiver for the upper transmission bands according to the invention the controls simultaneously conductively control the first and the second switch diode in the transceiver of the lower transmission band as well as the switch diode located parallel to the signal input of the receiving unit in the other transceiver with the bias current.

The solution according to the invention works thus as follows:

While the transmitting unit in the transceiver of the lower transmission band is active the signal inputs are short circuited by both receiving units. Simultaneously the switch diode located serially to the transmitting output of the transmitting unit for the upper transmission band is negatively biased by the dimension of one diode forward voltage. The transformer in the transceiver of the upper transmission band is mismatched for the transmitting signal coupled in from the lower transmission band. This prevents the short circuit at the signal input of the receiving unit for the upper transmission band being transformed into an open circuit. Thus the portion of the signal coupled into the antenna terminal is diverted against earth via the transformer and the conductive switch diode.

In addition, by this measure bias values are set for both switch diodes in the passive transceiver of such a kind that the coupled in signal has to have substantially larger signal amplitudes for harmonic waves to arise.

Details of the invention will be explained below using drawings. The drawings show in detail:

FIG. 1 an antenna changeover switch for a single-band mobile station according to the prior art.

FIG. 2 an antenna changeover switch for a dual-band mobile station with the solution according to the invention.

FIG. 1 has been sufficiently described above, so further explanations are not necessary. FIG. 2 shows beyond the already described functional elements two impedors Z1, Z3 located serially to the switches S1 and S2. They can in the simplest case be constructed as R/C deep-passes or preferably as L/R/C deep-passes. As the impedors Z1, Z3 are located directly at the transmitting output of the transmitting units, their HF impedance and the attenuation must be of such a level that no harmonic waves can arise at the switches S1 and S2 constructed with semiconductor components. Parallel to the impedor Z1 is an additional impedor Z2. This represents the only extra expenditure needed to implement the solution according to the invention. In the simplest case the impedor Z2 can be an ohmic resistance, as to implement the deep-pass functions the impedors Z1 and Z2 can use HF condensers in common.

An advantage of the invention is thus that the solution according to the invention achieves high attenuation of the coupled in portion of the signal with minimal additional expenditure.

The impedors Z1, Z2 and Z3 in addition set the bias currents of the switch diodes. Another way of feeding in the bias currents is conceivable. As the transmitting powers of the transmitting units are, however, relatively high, the bias current has to be correspondingly high for at least the switch diodes D1 and D3. Otherwise harmonic waves would arise. In the interest of low current consumption the present serial circuit of the switch diodes D1, D2 or D3, D4 is therefore optimal. For the same reason the impedor Z2 can be dimensioned in such a way that the current through the diode* is less than that through the diodes D1 and D2.

Between the output of the transmitting unit TX2 and earth another high-resistance Z4 (>>50 ohm) can be located which ensures that the diode D3 is biased backwards when TX1 is active. It is not necessary if by chance another DC path against earth is present.

To avoid interference outside the HF transmission band being used during transmitting there are preferably between the receivers and the diplex filter DF deep-pass filters F1 and F2 which have a low attenuation for the fundamental wave of the corresponding transmitting signal, yet effectively suppress the harmonic waves. This has the advantage that the measure according to the invention only has to be applied when the GSM 900 transceiver is active. If the DCS 1800 transceiver is active on the one hand the deep-pass filter F1 ensures that the higher frequency fundamental wave of the DCS band arrives at the antenna terminal A1 with higher attenuation. On the other hand the deep-pass filter F1 effectively suppresses the first harmonic wave, which is around 3600 MHz, in the direction from the antenna terminal A1 to the antenna ANT.

In the present example the transmitting units TX1, TX2 advantageously control the switches S1 and S2 directly.

1. Antenna changeover switch for transmit-receive units in a mobile station with a first transceiver for an upper transmission band (DCS 1800) and at least one second transceiver for a lower transmission band (GSM 900) which separately have in each case a transmitting unit (TX1 or TX2) and a receiving unit (RX1 or RX2) and in addition contain:
a first switch diode (D1 or D3), located serially to the signal output of the transmitting unit (TX1 or TX2),
a second switch diode (D2 or D4) located parallel to the signal input of the receiving unit (RX1 or RX2),
an HF impedance transformer (L1 or L2), located serially to the signal input, which transforms a short circuit of the signal input into an open circuit for signal frequencies in the corresponding transmission band (GSM 900 or DCS 1800) and
controls (S1, S2) for actuating a transceiver, which during transmitting control the first and second switch diode (D1, D2 or D3, D4) in the active transceiver conductively by means of a bias current, so the signal output of the active transmitting unit (TX1 or TX2) is connected to a common transmit-receive antenna via an antenna terminal (A1 or A2) and a changeover switch (DF), and the signal input of the receiving unit (RX1 or RX2) is short circuited, wherein
the controls (S1) are constructed in such a way that they simultaneously conductively control the switch diodes (D1, D2) in the transceiver of the lower transmission band (GSM 900) and the switch diode (D4) located in the transceiver of the upper transmission band (DCS 1800) parallel to the signal input of the receiving unit (RX2).

2. Antenna changeover switch according to claim 1, characterised in that the impedance transformers (L1, L2) are different λ/4 lines, which are substantially tuned to the average carrier frequency of the transmitting frequencies of the corresponding transmission band (GSM 900 or DCS 1800).

3. Antenna changeover switch according to claim 1, characterised in that at least between the antenna terminal (A1) of the transceiver for the lower transmission band (GSM 900) and the changeover switch (DF) is located a deep-pass filter (F1) which has a low attenuation for the fundamental wave of the transmitting signal in the lower transmission band (GSM 900), but already effectively suppresses the harmonic wave thereof.

4. Antenna changeover switch according to claim 1, characterised in that the bias currents for the switch diodes (D1-D4) are supplied by a switch signal of the respectively active transmitting unit (TX1 or TX2).

5. Antenna changeover switch according to claim 1, characterised in that the changeover switch is a semiconductor changeover switch.

6. Antenna changeover switch according to claim 1, characterised in that the changeover switch is constructed as a diplex filter (DF).
